(19) United States
(12) Patent Application Publication
(10) Pub. No.: US 2011/0211057 A1
(43) Pub. Date: Sep. 1, 2011

(54) IMAGE PROCESSING APPARATUS, IMAGE PROCESSING METHOD, PROGRAM, AND PROGRAM RECORDING MEDIUM

(75) Inventors: Yoshihiko Iwase, Yokohama-shi (JP); Hiroshi Imamura, Tokyo (JP); Daisuke Furukawa, Koganei-shi (JP)

(73) Assignee: CANON KABUSHIKI KAISHA, Tokyo (JP)

(21) Appl. No.: 13/062,483

(22) PCT Filed: Nov. 9, 2009
(86) PCT No.: PCT/JP2009/005935

§ 371 Date: Mar. 4, 2011

(30) Foreign Application Priority Data
Nov. 10, 2008 (JP) 2008-287754

(51) Int. Cl. G06K 9/00; H04N 7/18

(52) U.S. Cl. 348/78; 382/131; 348/E07.085

(57) ABSTRACT

An image processing unit obtains information indicating continuity of tomograms of a subject's eye, and a determining unit determines the image capturing state of the subject's eye on the basis of the information obtained by the image processing unit.

### TECHNICAL FIELD

The present invention relates to an image processing system that supports capturing of an image of an eye, and more particularly, to an image processing system using tomograms of an eye.

### BACKGROUND ART

For the purpose of conducting early diagnoses of various diseases that occupy the top places of the causes of adult diseases and blindness, eye examinations are widely conducted. In examinations and the like, it is requested to find diseases of the entirety of an eye. Therefore, examinations using images of a wide area of an eye (hereinafter called wide images) are essential. Wide images are captured using, for example, a retinal camera or a scanning laser ophthalmoscope (SLO). In contrast, eye tomogram capturing apparatuses such as an optical coherence tomography (OCT) apparatus can observe the three-dimensional state of the interior of retina layers, and therefore, it is expected that these eye tomogram capturing apparatuses are useful in accurately conducting diagnoses of diseases. Hereinafter, an image captured with an OCT apparatus will be referred to as a tomogram or tomogram volume data.

When an image of an eye is to be captured using an OCT apparatus, it takes some time from the beginning of image capturing to the end of image capturing. During this time, the eye being examined (hereinafter this will be referred to as the subject's eye) may suddenly move or blink, resulting in a shift or distortion in the image. However, such a shift or distortion in the image may not be recognized while the image is being captured. Also, such a shift or distortion may be overlooked when the captured image data is checked after the image capturing is completed because of the vast amount of the image data. Since this checking operation is not easy, the diagnosis workflow of a doctor is inefficient.

To overcome the above-described problems, the technique of detecting blinking when an image is being captured (Japanese Patent Laid-Open No. 62-281923) and the technique of correcting a positional shift in a tomogram due to the movement of the subject's eye (Japanese Patent Laid-Open No. 2007-130403) are disclosed.

However, the known techniques have the following problems.

In the method described in the foregoing Japanese Patent Laid-Open No. 62-281923, blinking is detected using an eyelid open/close detector. When the eyelid level changes from a closed level to an open level, an image is captured after a predetermined time set by a delay time setter has elapsed. Therefore, although blinking can be detected, a shift or distortion in the image due to the movement of the subject's eye cannot be detected. Thus, the image capturing state including the movement of the subject's eye cannot be obtained.

Also, the method described in Japanese Patent Laid-Open No. 2007-130403 is performed to align two or more tomograms using a reference image (one tomogram orthogonal to two or more tomograms, or an image of the fundus of an eye). Therefore, when the eye greatly moves, the tomograms are corrected, but no accurate image can be generated. Also, there is no concept to detect the image capturing state, which is the state of the subject's eye at the time the image is captured.

### Citation List

### Patent Literature

### PTL 1: Japanese Patent Laid-Open No. 62-281923

### PTL 2: Japanese Patent Laid-Open No. 2007-130403

### SUMMARY OF INVENTION

The present invention provides an image processing system that determines the accuracy of a tomogram.

According to an aspect of the present invention, there is provided an image processing apparatus for determining the image capturing state of a subject's eye, including an image processing unit configured to obtain information indicating continuity of tomograms of the subject's eye; and a determining unit configured to determine the image capturing state of the subject's eye on the basis of the information obtained by the image processing unit.

According to another aspect of the present invention, there is provided an image processing method of determining the image capturing state of a subject's eye, including an image processing step of obtaining information indicating continuity of tomograms of the subject's eye; and a determining step of determining the image capturing state of the subject's eye on the basis of the information obtained in the image processing step.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram illustrating the structure of devices connected to an image processing system 10.

FIG. 2 is a block diagram illustrating a functional structure of the image processing system 10.

FIG. 3 is a flowchart illustrating a process performed by the image processing system 10.

FIG. 4A is an illustration of an example of tomograms.

FIG. 4B is an illustration of an example of an integrated image.

FIG. 5A is an illustration of an example of an integrated image.

FIG. 5B is an illustration of an example of an integrated image.

FIG. 6 is an illustration of an example of a screen display.

FIG. 7A is an illustration of an image capturing state.

FIG. 7B is an illustration of an image capturing state.

FIG. 7C is an illustration of the relationship between the image capturing state and the degree of concentration of blood vessels.

FIG. 7D is an illustration of the relationship between the image capturing state and the degree of similarity.

FIG. 8 is a block diagram illustrating the basic structure of the image processing system 10.

FIG. 9A is an illustration of an example of an integrated image.

FIG. 9B is an illustration of an example of a gradient image.

FIG. 10A is an illustration of an example of an integrated image.

FIG. 10B is an illustration of an example of a power spectrum.

FIG. 11 is a flowchart illustrating a process.

FIG. 12A is an illustration for describing features of a tomogram.

FIG. 12B is an illustration for describing features of a tomogram.

FIG. 13 is a flowchart illustrating a process.

FIG. 14A is an illustration of an example of an integrated image.

FIG. 14B is an illustration of an example of partial images.

FIG. 14C is an illustration of an example of an integrated image.

FIG. 15A is an illustration of an example of a blood vessel model.

FIG. 15B is an illustration of an example of partial models.

FIG. 15C is an illustration of an example of a blood vessel model.

FIG. 16A is an illustration of an example of a screen display.

FIG. 16B is an illustration of an example of a screen display.

FIG. 16C is an illustration of an example of a screen display.

### DESCRIPTION OF EMBODIMENTS

Preferred embodiments of the present invention will now be described in detail in accordance with the accompanying drawings. However, the scope of the present invention is not limited to examples illustrated in the drawings.

### First Embodiment

An image processing apparatus according to the present embodiment generates an integrated image from tomogram volume data when tomograms of a subject's eye (eye serving as an examination target) are obtained, and determines the accuracy of the captured images by using the continuity of image features obtained from the integrated image.

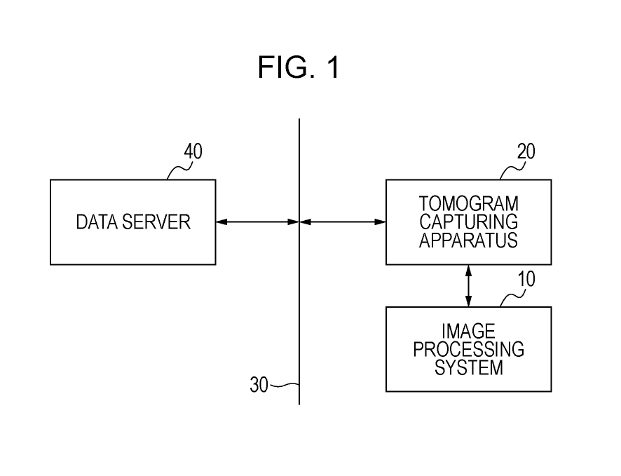

FIG. 1 is a block diagram of devices connected to an image processing system 10 according to the present embodiment. As illustrated in FIG. 1, the image processing system 10 is connected to a tomogram capturing apparatus 20 and a data server 40 via a local area network (LAN) 30 such as Ethernet (registered trademark). The connection with these devices may be established using an optical fiber or an interface such as universal serial bus (USB) or Institute of Electrical and Electronic Engineers (IEEE) 1394. The tomogram capturing apparatus 20 is connected to the data server 40 via the LAN 30 such as Ethernet (registered trademark). The connection with the devices may be established using an external network such as the Internet.

The tomogram capturing apparatus 20 is an apparatus that captures a tomogram of an eye. The tomogram capturing apparatus 20 is, for example, an OCT apparatus using time domain OCT or Fourier domain OCT. In response to an operation entered by an operator (not shown), the tomogram capturing apparatus 20 captures a three-dimensional tomogram of a subject's eye (not shown). The tomogram capturing apparatus 20 sends the obtained tomogram to the image processing system 10.

The data server 40 is a server that holds a tomogram of a subject's eye and information obtained from the subject's eye. The data server 40 holds a tomogram of a subject's eye, which is output from the tomogram capturing apparatus 20, and the result output from the image processing system 10. In response to a request from the image processing system 10, the data server 40 sends past data regarding the subject's eye to the image processing system 10.

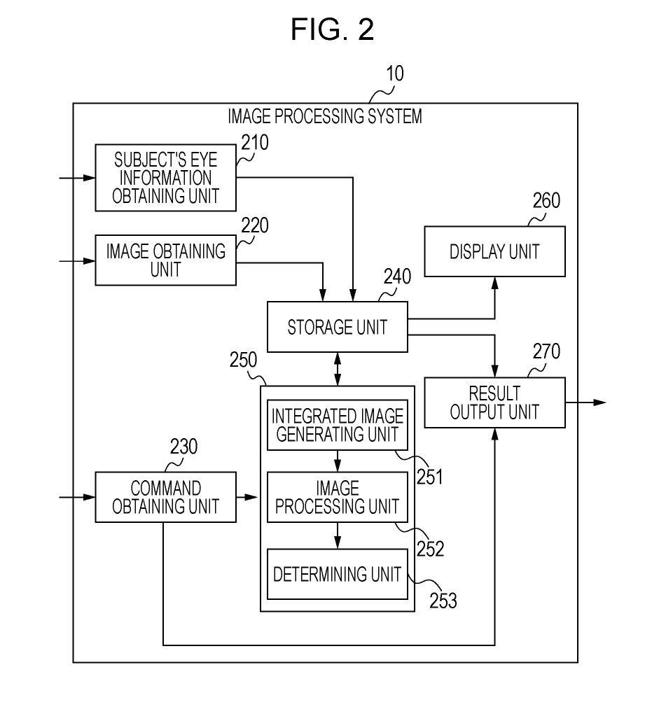

Referring now to FIG. 2, the functional structure of the image processing system 10 according to the present embodiment will be described. FIG. 2 is a functional block diagram of the image processing system 10. As illustrated in FIG. 2, the image processing system 10 includes a subject's eye information obtaining unit 210, an image obtaining unit 220, a command obtaining unit 230, a storage unit 240, an image processing apparatus 250, a display unit 260, and a result output unit 270.

The subject's eye information obtaining unit 210 obtains information for identifying a subject's eye from the outside. Information for identifying a subject's eye is, for example, a subject identification number assigned to each subject's eye. Alternatively, information for identifying a subject's eye may include a combination of a subject identification number and an identifier that represents whether an examination target is the right eye or the left eye.

Information for identifying a subject's eye is entered by an operator. When the data server 40 holds information for identifying a subject's eye, this information may be obtained from the data server 40.

The image obtaining unit 220 obtains a tomogram sent from the tomogram capturing apparatus 20. In the following description, it is assumed that a tomogram obtained by the image obtaining unit 220 is a tomogram of a subject's eye identified by the subject's eye information obtaining unit 210. It is also assumed that various parameters regarding the capturing of the tomogram are attached as information to the tomogram.

The command obtaining unit 230 obtains a process command entered by an operator. For example, the command obtaining unit 230 obtains a command to start, interrupt, end, or resume an image capturing process, a command to save or not to save a captured image, and a command to specify a saving location. The details of a command obtained by the command obtaining unit 230 are sent to the image processing apparatus 250 and the result output unit 270 as needed.

The storage unit 240 temporarily holds information regarding a subject's eye, which is obtained by the subject's eye information obtaining unit 210. Also, the storage unit 240 temporarily holds a tomogram of the subject's eye, which is obtained by the image obtaining unit 220. Further, the storage unit 240 temporarily holds information obtained from the tomogram, which is obtained by the image processing apparatus 250 as will be described later. These items of data are sent to the image processing apparatus 250, the display unit 260, and the result output unit 270 as needed.

The image processing apparatus 250 obtains a tomogram held by the storage unit 240, and executes a process on the tomogram to determine continuity of tomogram volume data. The image processing apparatus 250 includes an integrated image generating unit 251, an image processing unit 252, and a determining unit 253.

The integrated image generating unit 251 generates an integrated image by integrating tomograms in a depth direction. The integrated image generating unit 251 performs a process of integrating, in a depth direction, n two-dimensional tomograms captured by the tomogram capturing apparatus 20. Here, two-dimensional tomograms will be referred to as cross-sectional images. Cross-sectional images include, for example, B-scan images and A-scan images. The specific details of the process performed by the integrated image generating unit 251 will be described in detail later.

The image processing unit 252 extracts, from tomograms, information for determining three-dimensional continuity. The specific details of the process performed by the image processing unit 252 will be described in detail later.

The determining unit 253 determines continuity of tomogram volume data (hereinafter this may also be referred to as tomograms) on the basis of information extracted by the image processing unit 252. When the determining unit 253 determines that items of tomogram volume data are not continuous, the display unit 260 displays the determination result. The specific details of the process performed by the determining unit 253 will be described in detail later. On the basis of information extracted by the image processing unit 252, the determining unit 253 determines how much the subject's eye moved or whether the subject's eye blinked

The display unit 260 displays, on a monitor, tomograms obtained by the image obtaining unit 220 and the result obtained by processing the tomograms using the image processing apparatus 250. The specific details displayed by the display unit 260 will be described in detail later.

The result output unit 270 associates an examination time and date, information for identifying a subject's eye, a tomogram of the subject's eye, and an analysis result obtained by the image obtaining unit 220, and sends the associated information as information to be saved to the data server 40.

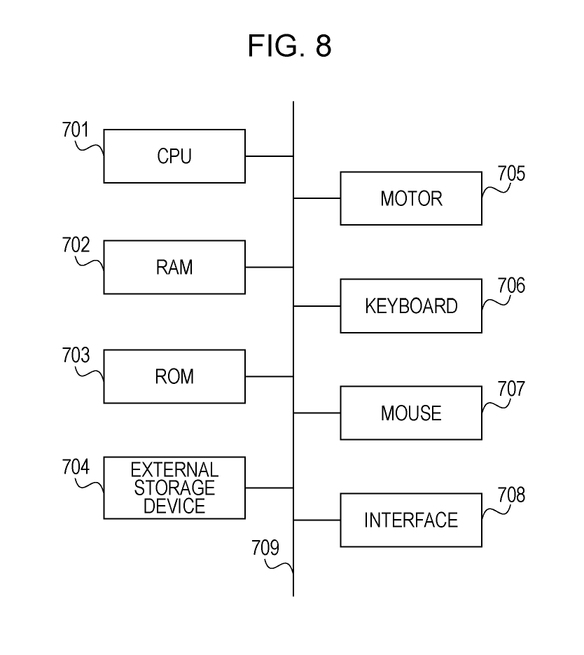

FIG. 8 is a diagram illustrating the basic structure of a computer for realizing the functions of the units of the image processing system 10 by using software.

A central processing unit (CPU) 701 controls the entire computer by using programs and data storage in a random-access memory (RAM) 702 and/or a read-only memory (ROM) 703. The CPU 701 also controls execution of software corresponding to the units of the image processing system 10 and realizes the functions of the units. Note that programs may be loaded from a program recording medium and stored in the RAM 702 and/or the ROM 703.

The RAM 702 has an area that temporarily stores programs and data loaded from an external storage device 704 and a work area needed for the CPU 701 to perform various processes. The function of the storage unit 240 is realized by the RAM 702.

The ROM 703 generally stores a basic input/output system (BIOS) and setting data of the computer. The external storage device 704 is a device that functions as a large-capacity information storage device, such as a hard disk drive, and stores an operating system and programs executed by the CPU 701. Information regarded as being known in the description of the present embodiment is saved in the ROM 703 and is loaded to the RAM 702 as needed.

A monitor 705 is a liquid crystal display or the like. The monitor 705 can display the details output by the display unit 260, for example.

A keyboard 706 and a mouse 707 are input devices. By operating these devices, an operator can give various commands to the image processing system 10. The functions of the subject's eye information obtaining unit 210 and the command obtaining unit 230 are realized via these input devices.

An interface 708 is configured to exchange various items of data between the image processing system 10 and an external device. The interface 708 is, for example, an IEEE 1394, USB, or Ethernet (registered trademark) port. Data obtained via the interface 708 is taken into the RAM 702. The functions of the image obtaining unit 220 and the result output unit 270 are realized via the interface 708.

The above-described components are interconnected by a bus 709.

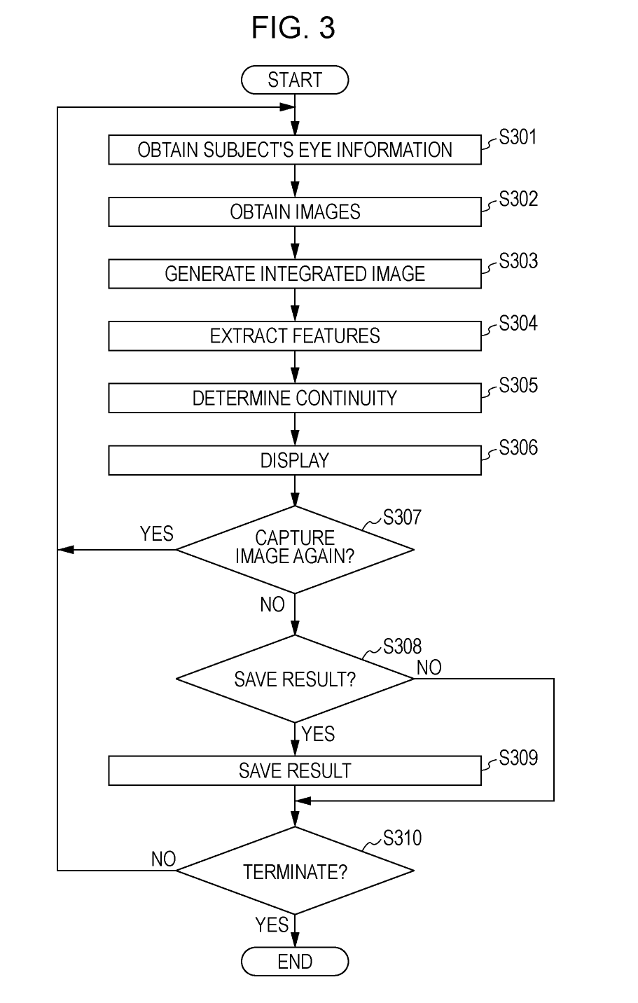

Referring now to the flowchart illustrated in FIG. 3, a process performed by the image processing system 10 of the present embodiment will be described. The functions of the units of the image processing system 10 in the present embodiment are realized by the CPU 701, which executes programs that realize the functions of the units and controls the entire computer. It is assumed that, before performing the following process, program code in accordance with the flowchart is already loaded from, for example, the external storage device 704 to the RAM 702.

### Step S301

In step S301, the subject's eye information obtaining unit 210 obtains a subject identification number as information for identifying a subject's eye from the outside. This information is entered by an operator by using the keyboard 706, the mouse 707, or a card reader (not shown). On the basis of the subject identification number, the subject's eye information obtaining unit 210 obtains information regarding the subject's eye, which is held by the data server 40. This information regarding the subject's eye includes, for example, the subject's name, age, and sex. When there are other items of examination information including measurement data of, for example, the eyesight, length of the eyeball, and intraocular pressure, the subject's eye information obtaining unit 210 may obtain the measurement data. The subject's eye information obtaining unit 210 sends the obtained information to the storage unit 240.

When an image of the same eye is captured again, this processing in step S301 may be skipped. When there is new information to be added, this information is obtained in step S301.

### Step S302

In step S302, the image obtaining unit 220 obtains tomograms sent from the tomogram capturing apparatus 20. The image obtaining unit 220 sends the obtained information to the storage unit 240.

### Step S303

In step S303, the integrated image generating unit 251 generates an integrated image by integrating cross-sectional images (e.g., B-scan images) in a depth direction.

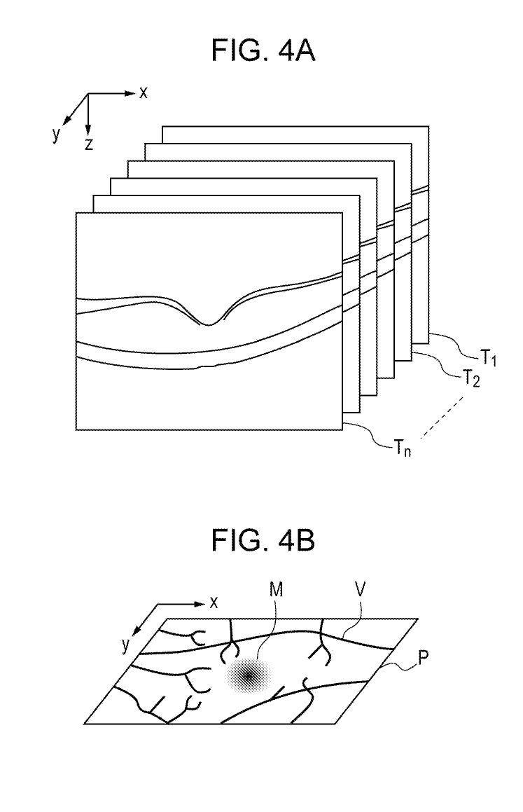

Hereinafter, a process performed by the integrated image generating unit 251 will be described using FIGS. 4A and 4B. FIG. 4A is an illustration of examples of tomograms, and FIG. 4B is an illustration of an example of an integrated image. Specifically, FIG. 4A illustrates cross-sectional images T₁ to Tₙ, of a macula lutea, and FIG. 4B illustrates an integrated image P generated from the cross-sectional images T₁ to Tₙ. The depth direction is a z-direction in FIG. 4A. Integration in the depth direction is a process of adding light intensities (luminance values) at depth positions in the z-direction in FIG. 4A. The integrated image P may simply be based on the sum of luminance values at depth positions, or may be based on an average obtained by dividing the sum by the number of values added. The integrated image P may not necessarily be generated by adding luminance values of all pixels in the depth direction, and may be generated by adding luminance values of pixels within an arbitrary range. For example, the entirety of retina layers may be detected in advance, and luminance values of pixels only in the retina layers may be added. Alternatively, luminance values of pixels only in an arbitrary layer of the retina layers may be added. The integrated image generating unit 251 performs this process of integrating, in the depth-direction, n cross-sectional images T₁ to Tₙ captured by the tomogram capturing apparatus 20, and generates an integrated image P. The integrated image P illustrated in FIG. 4B is represented in such a manner that luminance values are greater when the integrated value is greater, and luminance values are smaller when the integrated value is smaller. Curves V in the integrated image P in FIG. 4B represent blood vessels, and a circle M at the center of the integrated image P represents the macula lutea. The tomogram capturing apparatus 20 captures cross-sectional images T₁ to Tₙ of the eye by receiving, with photo detectors, reflected light of light emitted from a low-coherence light source. At places where there are blood vessels, the intensity of reflected light at positions deeper than the blood vessels tends to be weaker, and a value obtained by integrating the luminance values in the z-direction becomes smaller than that obtained at places where there are no blood vessels. Therefore, by generating the integrated image P, an image with contrast between blood vessels and other portions can be obtained.

### Step S304

In step S304, the image processing unit 252 extracts information for determining continuity of tomogram volume data from the integrated image.

The image processing unit 252 detects blood vessels in the integrated image as information for determining continuity of tomogram volume data. A method of detecting blood vessels is a generally known technique, and a detailed description thereof will be omitted. Blood vessels may not necessarily be detected using one method, and may be detected using a combination of multiple techniques.

### Step S305

In step S305, the determining unit 253 performs a process on the blood vessels obtained in step S304 and determines continuity of tomogram volume data.

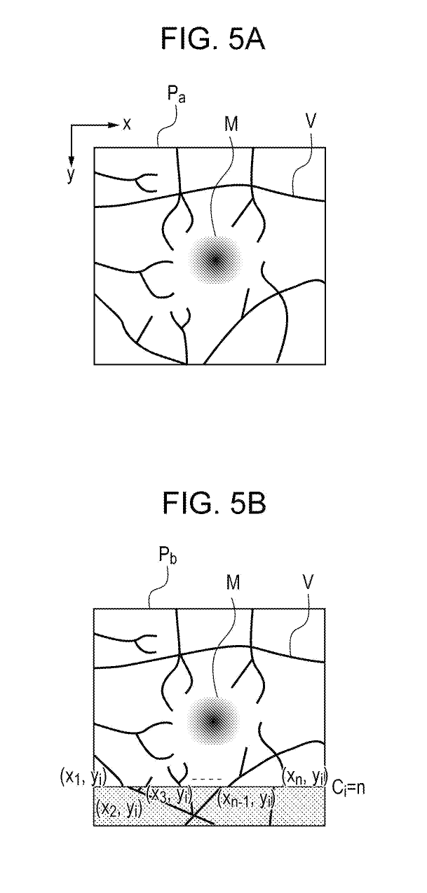

Hereinafter, a specific process performed by the determining unit 253 will be described using FIGS. 5A and 5B. FIGS. 5A and 5B are illustrations of an example of an integrated image. FIG. 5A illustrates an example of a macula lutea integrated image Pₐ when the image capturing was successful. FIG. 5B illustrates an example of a macula lutea integrated image P_{b} when the image capturing was unsuccessful. In FIGS. 5A and 5B, the scanning direction at the time of image capturing using OCT is parallel to the x-direction. Since blood vessels of an eye are concentrated at the optic disk and blood vessels run from the optic disk to the macula lutea, blood vessels are concentrated near the macula lutea. Hereinafter, an end portion of a blood vessel will be referred to as a blood vessel end. A blood vessel end in a tomogram corresponds to one of two cases: In one case, the blood vessel end in the tomogram is an end of a blood vessel of a subject in the captured image. In the other case, the subject's eyeball moved at the time the image was captured. As a result, a blood vessel in the captured image becomes broken, and this seems as a blood vessel end in the captured image.

The image processing unit 252 tracks, from blood vessels that are concentrated near the macula lutea, the individual blood vessels, and labels the tracked blood vessels as “tracked”. The image processing unit 252 stores the positional coordinates of the tracked blood vessel ends as position information in the storage unit 240. The image processing unit 252 counts together the positional coordinates of blood vessel ends existing on a line parallel to the scanning direction at the time of image capturing using OCT (x-direction). This represents the number of blood vessel ends in tomograms. For example, the image processing unit 252 counts together the points (x₁, yᵢ), (x₂, yᵢ), (x₃, yᵢ), . . . (xₙ₋₁, yᵢ),(nₙ, yᵢ) existing on the same y-coordinate. When the image capturing using OCT was successful as in FIG. 5A, the coordinates of blood vessel ends on a line parallel to the scanning direction at the time of image capturing using OCT are less likely to be concentrated. However, when the image capturing using OCT was unsuccessful as in FIG. 5B, a positional shift occurs between cross-sectional images (B-scan images), and hence, blood vessel ends are concentrated on a line at the boundary where the positional shift has occurred. Therefore, when the coordinates of multiple blood vessel ends exist on a line parallel to the scanning direction at the time of image capturing using OCT (x-direction), it is highly likely that the image capturing was unsuccessful. The determining unit 253 determines whether the image capturing was unsuccessful on the basis of a threshold Th of the degree of concentration of blood vessel ends. For example, the determining unit 253 makes the determination on the basis of the following equation (1). In equation (1), C_{y} denotes the degree of concentration of blood vessel ends, a subscript denotes the y-coordinate, and Y denotes the image size. When the degree of concentration of blood vessel ends is greater than or equal to the threshold Th, the determining unit 253 determines that the cross-sectional images are not continuous. That is, when the number of blood vessel ends in cross-sectional images is greater than or equal to the threshold Th, the determining unit 253 determines that the cross-sectional images are not continuous.

Therefore, the threshold Th may be a fixed threshold in terms of a numeral, or the ratio of the number of coordinates of blood vessel ends on a line to the number of coordinates of all blood vessel ends. Alternatively, the threshold Th may be set on the basis of statistic data or patient information (age, sex, and/or race). The degree of concentration of blood vessel ends is not limited to that obtained using blood vessel ends existing on a line. Taking into consideration variations of blood vessel detection, the determination may be made using the coordinates of blood vessel ends on two or more consecutive lines. When a blood vessel end is positioned at the border of the image, it may be regarded that this blood vessel is continued to the outside of the image, and the coordinate point of this blood vessel end may be excluded from the count. Here, the fact that a blood vessel end is positioned at the border of the image means that, in the case where the image size is (X, Y), the coordinates of the blood vessel end are (0, yⱼ), (X−1, yⱼ), (xⱼ, 0), or (xⱼ, Y−1). In this case, the fact that a blood vessel end is positioned at the border of the image is not limited to being on the border of the image; there may be a margin of a few pixels from the border of the image.

C_{y}≧Th; 0≦y≦Y−1

C_{y}<Th; 0≦y≦Y−1 [Math.1]

### Step S306

In step S306, the display unit 260 displays, on the monitor 705, the tomograms or cross-sectional images obtained in step S302. For example, images as schematically illustrated in FIGS. 4A and 4B are displayed. Here, since the tomograms are three-dimensional data, images that are actually displayed on the monitor 705 are cross-sectional images obtained by taking target cross sections from the tomograms, and these images which are actually displayed are two-dimensional tomograms. It is preferable that the cross-sectional images to be displayed be arbitrarily selectable by the operator via a graphical user interface (GUI) such as a slider or a button. Also, the patient data obtained in step S301 may be displayed together with the tomograms.

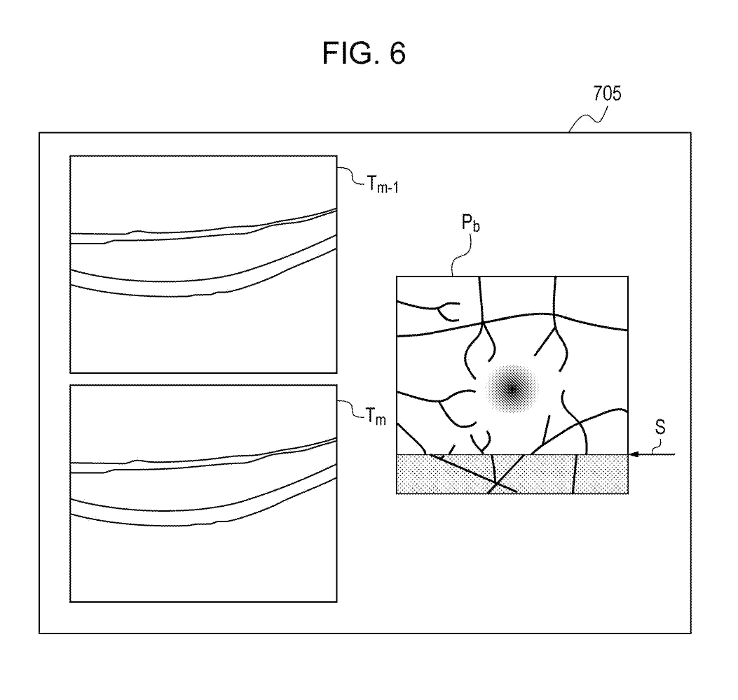

When the determining unit 253 determines in step S305 that the items of tomogram volume data are not continuous, the determining unit 253 displays that fact in step S306 using the display unit 260. FIG. 6 illustrates an example of a screen display. In FIG. 6, tomograms Tₘ₋₁ and Tₘ that are before and after the boundary at which discontinuity has been detected are displayed, and an integrated image P_{b} and a marker S indicating the place where there is a positional shift are displayed. However, a display example is not limited to this example. Only one of the tomograms that are before and after the boundary at which discontinuity has been detected may be displayed. Alternatively, no image may be displayed, and only the fact that discontinuity has been detected may be displayed.

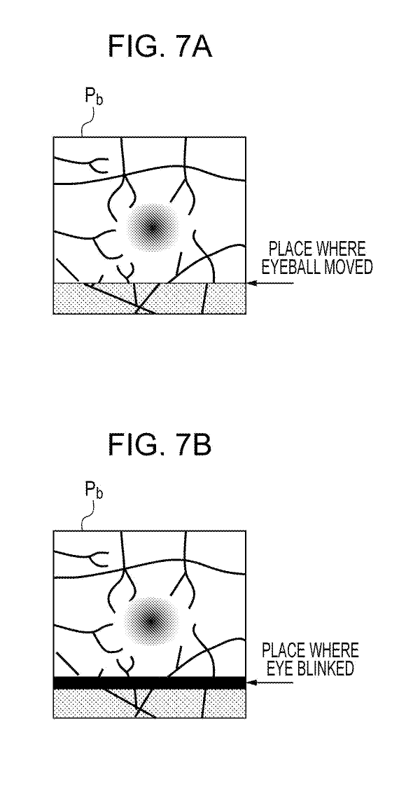

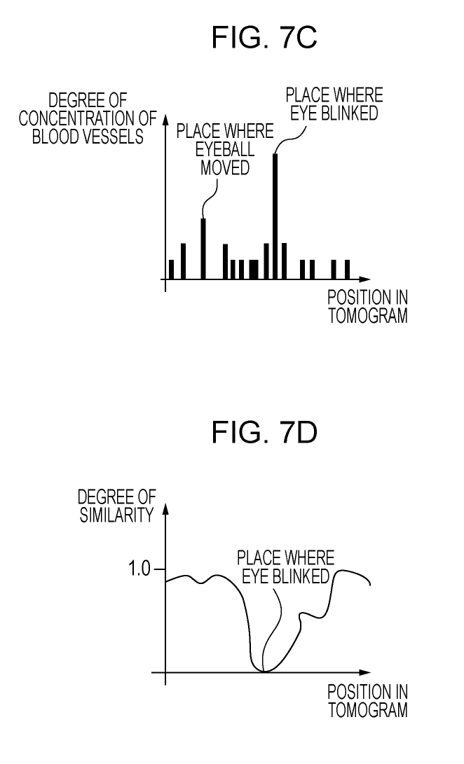

FIG. 7A illustrates a place where there is eyeball movement using an arrow. FIG. 7B illustrates a place where there is blinking using an arrow. FIG. 7C illustrates the relationship between the value of the degree of concentration of blood vessels, which is the number of blood vessel ends in cross-sectional images, and the state of the subject's eye. When the subject's eye blinks, blood vessels are completely interrupted, and hence, the degree of concentration of blood vessels becomes higher. The greater the eye movement, the more the blood vessel positions in cross-sectional images fluctuate between the cross-sectional images. Thus, the degree of concentration of blood vessels tends to be higher. That is, the degree of concentration of blood vessels indicates the image capturing state, such as the movement or blinking of the subject's eye. The image processing unit 252 can also compute the degree of similarity between cross-sectional images. The degree of similarity may be indicated using, for example, a correlation value between cross-sectional images. A correlation value is computed from the values of the individual pixels of the cross-sectional images. When the degree of similarity is 1, it indicates that the cross-sectional images are the same. The lower the degree of similarity, the greater the amount of the eyeball movement. When the eye blinks, the degree of similarity approaches 0. Therefore, the image capturing state such as how much the subject's eye moved or whether the subject's eye blinked can also be obtained from the degree of similarity between cross-sectional images. FIG. 7D illustrates the relationship between the degree of similarity and the position in cross-sectional images.

In this manner, the determining unit 253 determines continuity of tomograms, and determines the image capturing state, such as the movement or blinking of the subject's eye.

### Step S307

In step S307, the command obtaining unit 230 obtains, from the outside, a command to capture or not to capture an image of the subject's eye again. This command is entered by the operator via, for example, the keyboard 706 or the mouse 707. When a command to capture an image again is given, the flow returns to step S301, and the process on the same subject's eye is performed again. When no command to capture an image again is given, the flow proceeds to step S308.

### Step S308

In step S308, the command obtaining unit 230 obtains, from the outside, a command to save or not to save the result of this process on the subject's eye in the data server 40. This command is entered by the operator via, for example, the keyboard 706 or the mouse 707. When a command to save the data is given, the flow proceeds to step S309. When no command to save the data is given, the flow proceeds to step S310.

### Step S309

In step S309, the result output unit 270 associates the examination time and date, information for identifying the subject's eye, tomograms of the subject's eye, and information obtained by the image processing unit 252, and sends the associated information as information to be saved to the data server 40.

### Step S310

In step S310, the command obtaining unit 230 obtains, from the outside, a command to terminate or not to terminate the process on the tomograms. This command is entered by the operator via, for example, the keyboard 706 or the mouse 707. When a command to terminate the process is obtained, the image processing system 10 terminates the process. In contrast, when a command to continue the process is obtained, the flow returns to step S301, and the process on the next subject's eye (or the process on the same subject's eye again) is executed.

In the foregoing manner, the process performed by the image processing system 10 is conducted.

With the foregoing structure, whether tomograms are continuous is determined from an integrated image generated from items of tomogram volume data, and the result is presented to a doctor. Thus, the doctor can easily determine the accuracy of the tomograms of an eye, and the efficiency of the diagnosis workflow of the doctor can be improved. Further, the image capturing state such as the movement or blinking of the subject's eye at the time of image capturing using OCT can be obtained.

### Second Embodiment

In the present embodiment, the details of the process performed by the image processing unit 252 are different. A description of portions of the process that are the same as or similar to the first embodiment will be omitted.

The image processing unit 252 detects an edge region in the integrated image. By detecting an edge region parallel to the scanning direction at the time tomograms were captured, the image processing unit 252 obtains, in numeric terms, the degree of similarity between cross-sectional images constituting tomogram volume data.

When an integrated image is generated from tomogram volume data obtained by capturing tomograms of a position away from the retina since the eye moved at the time the tomograms were captured, the integrated value is different at a place where there is a positional shift due to the difference in the retina layer thickness.

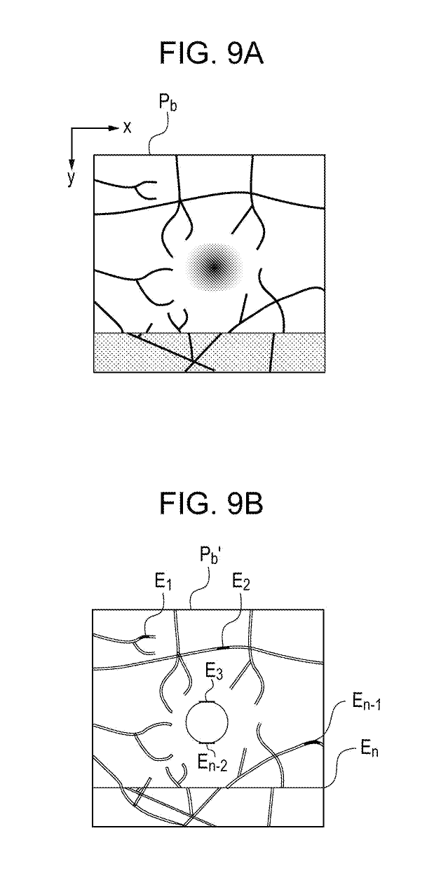

Alternatively, when the eye blinked at the time the tomograms were captured, the integrated value becomes 0 or extremely small. Thus, there is a luminance difference at a boundary where there is a positional shift or blinking FIG. 9A is an illustration of an example of an integrated image. FIG. 9B is an illustration of an example of a gradient image.

In FIGS. 9A and 9B, the scanning direction at the time the tomograms were captured is parallel to the x-direction. FIG. 9A illustrates an example of an integrated image P_{b} that is positionally shifted. FIG. 9B illustrates an example of an edge image P_{b}′ generated from the integrated image P_{b}. In FIG. 9B, reference E denotes an edge region parallel to the scanning direction at the time the tomograms were captured (x-direction). The edge image P_{b}′ is generated by removing noise components by applying a smoothing filter to the integrated image P_{b} and by using an edge detection filter such as a Sobel filter or a Canny filter. The filters applied here may be those without directionality or those that take directionality into consideration. When directionality is taken into consideration, it is preferable to use filters that enhance components parallel to the scanning direction at the time of image capturing using OCT.

The image processing unit 252 detects, in the edge image P_{b}′, a range of a certain number of consecutive edge regions that are parallel to the scanning direction at the time of image capturing using OCT (x-direction) and that are greater than or equal to a threshold. By detecting a certain number of consecutive edge regions E that are parallel to the scanning direction (x-direction), these can be distinguished from blood vessel edges and noise.

In the determination of the continuity of tomograms and the image capturing state of the subject's eye, the image processing unit 252 obtains, in numeric terms, the length of a certain number of consecutive edge regions E.

The determining unit 253 determines the continuity of tomograms and the image capturing state of the subject's eye by performing a comparison with a threshold Th′.

For example, the determination is made on the basis of the following equation (2) where E denotes the length of consecutive edge regions. The threshold Th′ may be a fixed value or may be set on the basis of statistic data. Alternatively, the threshold Th′ may be set on the basis of patient information (age, sex, and/or race). It is preferable that the threshold Th′ be dynamically changeable in accordance with the image size. For example, the smaller the image size, the smaller the threshold Th′. Further, the range of a certain number of consecutive edge regions is not limited to that on a parallel line. The determination can be made by using the range of a certain number of consecutive edge regions on two or more consecutive parallel lines.

E≧Th′ [Math.2]

### Third Embodiment

In the present embodiment, the image processing unit 252 performs a frequency analysis based on Fourier transform to extract frequency characteristics. The determining unit 253 determines whether items of tomogram volume data are continuous, in accordance with the strength in a frequency domain.

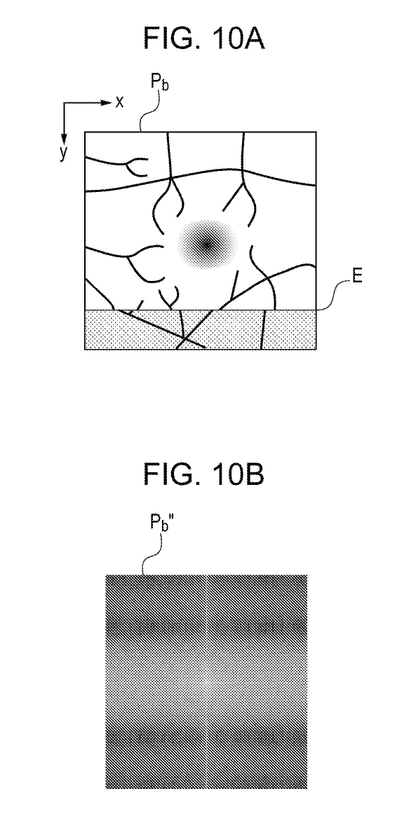

FIG. 10A is an illustration of an example of an integrated image. FIG. 10B is an illustration of an example of a power spectrum. Specifically, FIG. 10A illustrates an integrated image P_{b} generated when image capturing is unsuccessful due to a positional shift, and FIG. 10B illustrates a power spectrum P_{b}″ of the integrated image P_{b}. When there is a positional shift due to the eye movement at the image capturing time or when an eye blinks at the image capturing time, a spectrum orthogonal to the scanning direction at the time of image capturing using OCT is detected.

Using these results, the determining unit 253 determines the continuity of tomograms and the image capturing state of the subject's eye.

### Fourth Embodiment

The image processing system 10 according to the first embodiment obtains tomograms of a subject's eye, generates an integrated image from tomogram volume data, and determines the accuracy of the captured images by using the continuity of image features obtained from the integrated image. An image processing apparatus according to the present embodiment is similar to the first embodiment in that a process is performed on the obtained tomograms of the subject's eye. However, the present embodiment is different from the first embodiment in that, instead of generating an integrated image, the continuity of tomograms and the image capturing state of the subject's eye are determined from image features obtained from the tomograms.

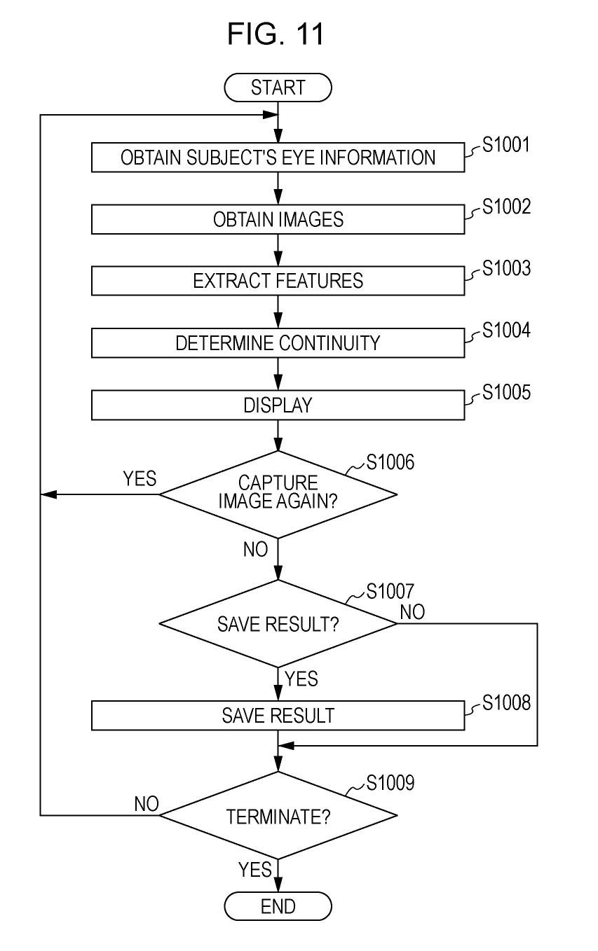

Referring now to the flowchart illustrated in FIG. 11, a process performed by the image processing system 10 of the present embodiment will be described. The processing in steps S1001, S1002, S1005, S1006, S1007, S1008, and S1009 is the same as the processing in steps S301, S302, S306, S307, S308, S309, and S310, and a description thereof is omitted.

### Step S1003

In step S1003, the image processing unit 252 extracts, from tomograms, information obtained for determining the continuity of tomogram volume data.

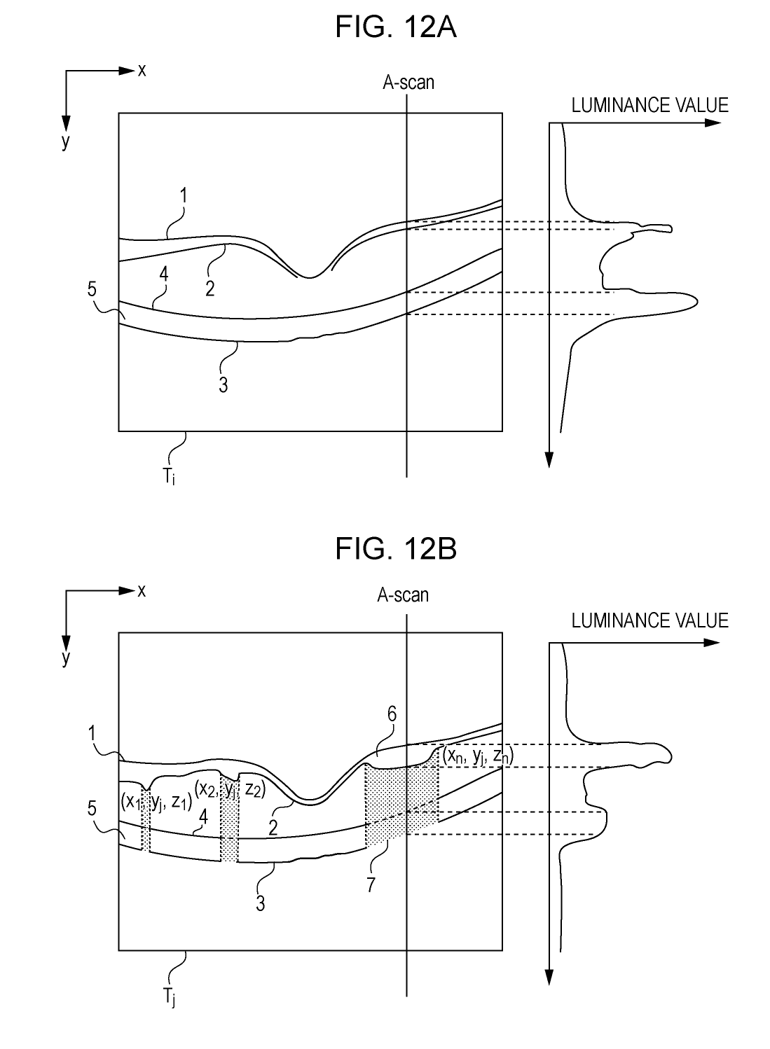

The image processing unit 252 detects, in the tomograms, a visual cell layer as a feature for determining the continuity of tomogram volume data, and detects a region in which a luminance value is low in the visual cell layer. Hereinafter, a specific process performed by the image processing unit 252 will be described using FIGS. 12A and 12B. FIGS. 12A and 12B are illustrations for describing features of a tomogram. That is, the left diagram of FIG. 12A illustrates a two-dimensional tomogram Tᵢ, and the right diagram of FIG. 12A illustrates a profile of an image along A-scan at a position at which there are no blood vessels in the left diagram. In other words, the right diagram illustrates the relationship between the coordinates and the luminance value on a line indicated as A-scan.

FIG. 12B includes diagrams similar to FIG. 12A and illustrates the case in which there are blood vessels. Two-dimensional tomograms Tᵢ and Tⱼ each include an inner limiting membrane 1, a nerve fiber layer boundary 2, a pigmented layer of the retina 3, a visual cell inner/outer segment junction 4, a visual cell layer 5, a blood vessel region 6, and a region under the blood vessel 7.

The image processing unit 252 detects the boundary between layers in tomograms. Here, it is assumed that a three-dimensional tomogram serving as a processing target is a set of cross-sectional images (e.g., B-scan images), and the following two-dimensional image processing is performed on the individual cross-sectional images. First, a smoothing filtering process is performed on a target cross-sectional image to remove noise components. In the tomogram, edge components are detected, and, on the basis of connectivity thereof, a few lines are extracted as candidates for the boundary between layers. From among these candidates, the top line is selected as the inner limiting membrane 1. A line immediately below the inner limiting membrane 1 is selected as the nerve fiber layer boundary 2. The bottom line is selected as the pigmented layer of the retina 3. A line immediately above the pigmented layer of the retina 3 is selected as the visual cell inner/outer segment junction 4. A region enclosed by the visual cell inner/outer segment junction 4 and the pigmented layer of the retina 3 is regarded as the visual cell layer 5. When there is not much change in the luminance value, and when no edge component greater than or equal to a threshold can be detected along A-scan, the boundary between layers may be interpolated by using coordinate points of a group of detection points on the left and right sides or in the entire region.

By applying a dynamic contour method such as a Snake or level set method using these lines as initial values, the detection accuracy may be improved. Using a technique such as graph cutting, the boundary between layers may be detected. Boundary detection using a dynamic contour method or a graph cutting technique may be performed three-dimensionally on a three-dimensional tomogram. Alternatively, a three-dimensional tomogram serving as a processing target may be regarded as a set of cross-sectional images, and such boundary detection may be performed two-dimensionally on the individual cross-sectional images. A method of detecting the boundary between layers is not limited to the foregoing methods, and any method can be used as long as it can detect the boundary between layers in tomograms of the eye.

As illustrated in FIG. 12B, luminance values in the region under the blood vessel 7 are generally low. Therefore, a blood vessel can be detected by detecting a region in which luminance values are generally low in the A-scan direction in the visual cell layer 5.

In the foregoing case, a region where luminance values are low is detected in the visual cell layer 5. However, a blood vessel feature is not limited thereto. A blood vessel may be detected by detecting a change in the thickness between the inner limiting membrane 1 and the nerve fiber layer boundary 2 (i.e., the nerve fiber layer) or a change in the thickness between the left and right sides. For example, as illustrated in FIG. 12B, when a change in the layer thickness is viewed in the x-direction, the thickness between the inner limiting membrane 1 and the nerve fiber layer boundary 2 suddenly becomes greater in a blood vessel portion. Thus, by detecting this region, a blood vessel can be detected. Furthermore, the foregoing processes may be combined to detect a blood vessel.

### Step S1004

In step S1004, the image processing unit 252 performs a process on the blood vessels obtained in step S1003, and determines continuity of tomogram volume data.

The image processing unit 252 tracks, from blood vessel ends near the macula lutea, the individual blood vessels, and labels the tracked blood vessels as “tracked”. The image processing unit 252 stores the coordinates of the tracked blood vessel ends in the storage unit 240. The image processing unit 252 counts together the coordinates of the blood vessel ends existing on a line parallel to the scanning direction at the time of image capturing using OCT. In the case of FIGS. 12A and 12B, when the scanning direction at the time of image capturing using OCT is parallel to the x-direction, points that exist at the same y-coordinate define a cross-sectional image (e.g., B-scan image). Therefore, in FIG. 12B, the image processing unit 252 counts together the co-ordinates(x₁, yⱼ, z₁), (x₂, yⱼ, z₂), . . . (xₙ, yⱼ, zₙ). When there is any change in the image capturing state of the subject's eye, a positional shift occurs between cross-sectional images (B-scan images). Thus, blood vessel ends are concentrated on a line at the boundary at which the positional shift occurred. Since the following process is the same as the first embodiment, a detailed description thereof is omitted.

With the foregoing structure, continuity of tomograms is determined from tomogram volume data, and the determination result is presented to a doctor. Therefore, the doctor can easily determine the accuracy of tomograms of the eye, and the efficiency of the diagnosis workflow of the doctor can be improved.

### Fifth Embodiment

The present embodiment describes the method of computing the degree of similarity in the first embodiment in a more detailed manner. The image processing unit 252 further includes a degree-of-similarity computing unit 254 (not shown), which computes the degree of similarity or difference between cross-sectional images. The determining unit 253 determines the continuity of tomograms and the image capturing state of the subject's eye by using the degree of similarity or difference. In the following description, it is assumed that the degree of similarity is to be computed.

The degree-of-similarity computing unit 254 computes the degree of similarity between consecutive cross-sectional images. The degree of similarity can be computed using the sum of squared difference (SSD) of a luminance difference or the sum of absolute difference (SAD) of a luminance difference. Alternatively, mutual information (MI) may be obtained. The method of computing the degree of similarity between cross-sectional images is not limited to the foregoing methods. Any method can be used as long as it can compute the degree of similarity between cross-sectional images. For example, the image processing unit 252 extracts a density value average or dispersion as a color or density feature, extracts a Fourier feature, a density cooccurence matrix, or the like as a texture feature, and extracts the shape of a layer, the shape of a blood vessel, or the like as a shape feature. By computing the distance in an image feature space, the degree-of-similarity computing unit 254 may determine the degree of similarity. The distance computed may be a Euclidean distance, a Mahalanobis distance, or the like.

The determining unit 253 determines that the consecutive cross-sectional images (B-scan images) have been normally captured when the degree of similarity obtained by the degree-of-similarity computing unit 254 is greater than or equal to a threshold. The degree-of-similarity threshold may be changed in accordance with the distance between two-dimensional tomograms or the scan speed. For example, given the case in which an image of a 6×6-mm range is captured in 128 slices (B-scan images) and the case in which the same image is captured in 256 slices (B-scan images), the degree of similarity between cross-sectional images becomes higher in the case of 256 slices. The degree-of-similarity threshold may be set as a fixed value or may be set on the basis of statistic data. Alternatively, the degree-of-similarity threshold may be set on the basis of patient information (age, sex, and/or race). When the degree of similarity is less than the threshold, it is determined that consecutive cross-sectional images are not continuous. Accordingly, a positional shift or blinking at the time the image was captured can be detected.

### Sixth Embodiment

An image processing apparatus according to the present embodiment is similar to the first embodiment in that a process is performed on the obtained tomograms of the subject's eye. However, the present embodiment is different from the foregoing embodiments in that a positional shift or blinking at the time the image was captured is detected from image features obtained from tomograms of the same patient that are captured at a different time in the past, and from image features obtained from the currently captured tomograms.

The functional blocks of the image processing system 10 according to the present embodiment are different from the first embodiment (FIG. 2) in that the image processing apparatus 250 has the degree-of-similarity computing unit 254 (not shown).

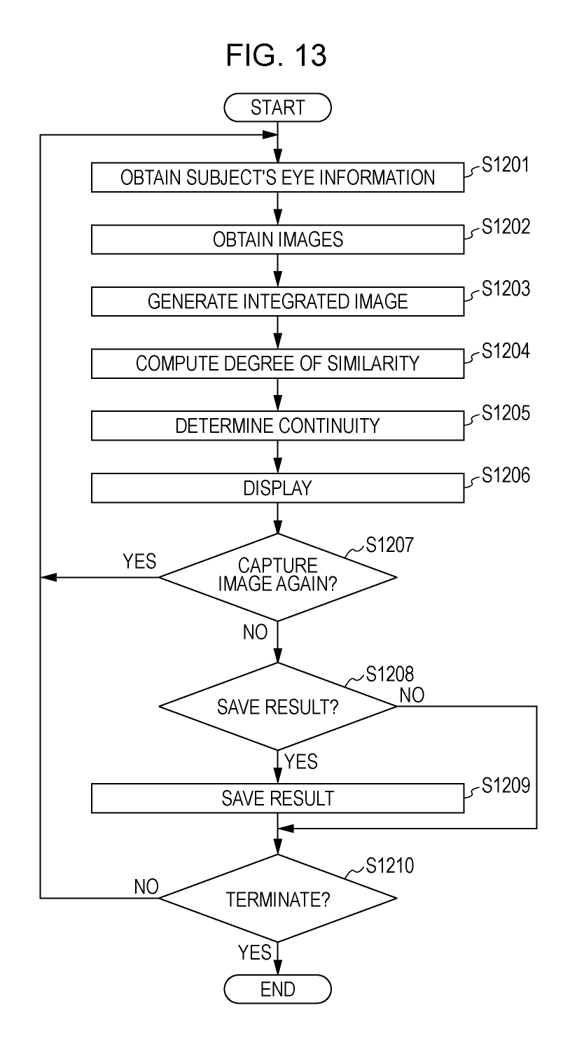

Referring now to the flowchart illustrated in FIG. 13, a process performed by the image processing system 10 of the present embodiment will be described. Since steps S1207, S1208, S1209, and S1210 in the present embodiment are the same as steps S307, S308, S309, and S310 in the first embodiment, a description thereof is omitted.

### Step S1201

In step S1201, the subject's eye information obtaining unit 210 obtains, from the outside, a subject identification number as information for identifying a subject's eye. This information is entered by an operator via the keyboard 706, the mouse 707, or a card reader (not shown). On the basis of the subject identification number, the subject's eye information obtaining unit 210 obtains information regarding the subject's eye, which is held in the data server 40. For example, the subject's eye information obtaining unit 210 obtains the name, age, and sex of the patient. Furthermore, the subject's eye information obtaining unit 210 obtains tomograms of the subject's eye that are captured in the past. When there are other items of examination information including measurement data of, for example, the eyesight, length of the eyeball, and intraocular pressure, the subject's eye information obtaining unit 210 may obtain the measurement data. The subject's eye information obtaining unit 210 sends the obtained information to the storage unit 240.

When an image of the same eye is captured again, this processing in step S1201 may be skipped. When there is new information to be added, this information is obtained in step S1201.

### Step S1202

In step S1202, the image obtaining unit 220 obtains tomograms sent from the tomogram capturing apparatus 20. The image obtaining unit 220 sends the obtained information to the storage unit 240.

### Step S1203

In step S1203, the integrated image generating unit 251 generates an integrated image by integrating cross-sectional images (e.g., B-scan images) in the depth direction. The integrated image generating unit 251 obtains, from the storage unit 240, the past tomograms obtained by the subject's eye information obtaining unit 210 in step S1201 and the current tomograms obtained by the image obtaining unit 220 in step S1202. The integrated image generating unit 251 generates an integrated image from the past tomograms and an integrated image from the current tomograms. Since a specific method of generating these integrated images is the same as that in the first embodiment, a detailed description thereof will be omitted.

### Step S1204

In step S1204, the degree-of-similarity computing unit 254 computes the degree of similarity between the integrated images generated from the tomograms captured at different times.

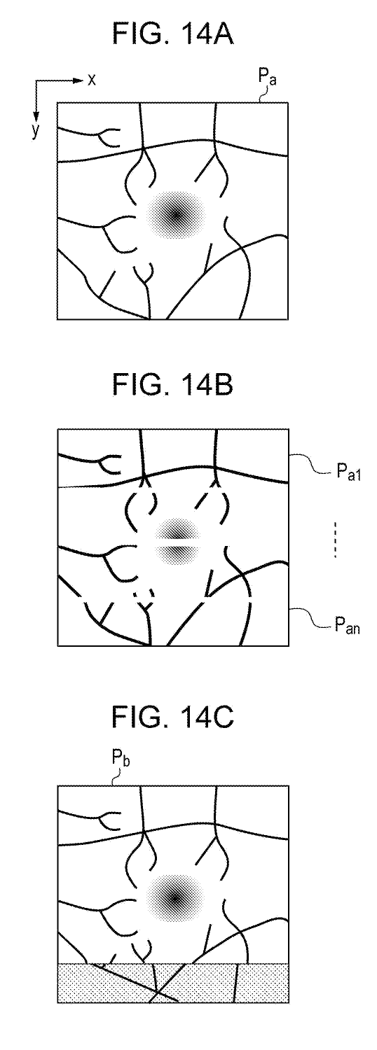

Hereinafter, a specific process performed by the degree-of-similarity computing unit 254 will be described using FIGS. 14A to 14C. FIGS. 14A to 14C are illustrations of examples of integrated images and partial images. Specifically, FIG. 14A is an illustration of an integrated image Pₐ generated from tomograms captured in the past. FIG. 14B is an illustration of partial integrated images Pₐ₁ to Pₐₙ generated from the integrated image Pₐ. FIG. 14C is an illustration of an integrated image P_{b} generated from tomograms that are currently captured. Here, it is preferable in the partial integrated images Pₐ₁ to Pₐₙ that a line parallel to the scanning direction at the time of image capturing using OCT be included in the same region. The division number n of the partial integrated images is an arbitrary number, and the division number n may be dynamically changed in accordance with the tomogram size (X, Y, Z).

The degree of similarity between images can be obtained using the sum of squared difference (SSD) of a luminance difference, the sum of absolute difference (SAD) of a luminance difference, or mutual information (MI). The method of computing the degree of similarity between integrated images is not limited to the foregoing methods. Any method can be used as long as it can compute the degree of similarity between images.

When the determining unit 253 computes the degree of similarity between each of the partial integrated images Pₐ₁ to Pₐₙ and the integrated image P_{b}, if all the degrees of similarity of the partial integrated images Pₐ₁ to Pₐₙ are greater than or equal to a threshold, the determining unit 253 determines that the eyeball movement is small and that the image capturing is successful.

If there is any partial integrated image whose degree of similarity is less than the threshold, the degree-of-similarity computing unit 254 further divides that partial integrated image into m images, and computes the degree of similarity between each of the divided m images and the integrated image P_{b} and determines a place (image) whose degree of similarity is greater than or equal to the threshold. These processes are repeated until it becomes impossible to further divide the partial integrated image or until a cross-sectional image whose degree of similarity is less than the threshold is specified. In an integrated image generated from tomograms captured in the case where the eyeball moves or the eye blinks, a positional shift occurs in the space, and hence, some of the partial integrated images in which the image capturing is successful are missing. Thus, the determining unit 253 determines that a partial integrated image whose degree of similarity is less than the threshold even when the partial integrated image is further divided into images or a partial integrated image whose degree of similarity is greater than or equal to the threshold at a positionally conflicting place (the order of partial integrated images is changed) is missing.

### Step S1205

When the degree of similarity computed by the degree-of-similarity computing unit 254 is greater than or equal to the threshold, the determining unit 253 determines that consecutive two-dimensional tomograms have been normally captured. If the degree of similarity is less than the threshold, the determining unit 253 determines that the tomograms are not consecutive. The determining unit 253 also determines that there was a positional shift or blinking at the image capturing time.

### Step S1206

In step S1206, the display unit 260 displays the tomograms obtained in step S1202 on the monitor 705. The details displayed on the monitor 705 are the same as those displayed in step S306 in the first embodiment. Alternatively, tomograms of the same subject's eye captured at a different time, which are obtained in step S1201, may additionally be displayed on the monitor 705.

In the present embodiment, an integrated image is generated from tomograms, the degree of similarity is computed, and continuity is determined. However, instead of generating an integrated image, the degree of similarity may be computed between tomograms, and continuity may be determined.

With the foregoing structure, continuity of tomograms is determined from the degree of similarity between integrated images generated from tomograms captured at different times, and the determination result is presented to a doctor. Therefore, the doctor can easily determine the accuracy of tomograms of the eye, and the efficiency of the diagnosis workflow of the doctor can be improved.

### Seventh Embodiment

In the present embodiment, the degree-of-similarity computing unit 254 computes the degree of similarity between blood vessel models generated from tomograms captured at different times, and the determining unit 253 determines continuity of tomogram volume data by using the degree of similarity.

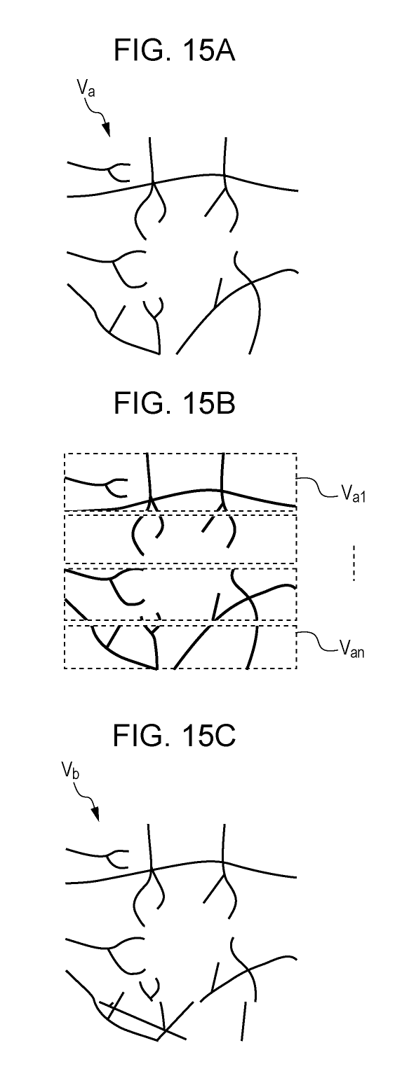

Since a method of detecting blood vessels by using the image processing unit 252 is the same as that in step S304 in the first embodiment, a description thereof will be omitted. For example, a blood vessel model is a multilevel image in which a blood vessel corresponds to 1 and other tissues correspond to 0 or only blood vessel portions correspond to grayscale and other tissues correspond to 0. FIGS. 15A to 15C illustrate examples of blood vessel models. That is, FIGS. 15A to 15C are illustrations of examples of blood vessel models and partial models. FIG. 15A illustrates a blood vessel model Vₐ generated from tomograms captured in the past. FIG. 15B illustrates partial models Vₐ₁ to Vₐₙ generated from the blood vessel model Vₐ. FIG. 15C illustrates a blood vessel model V_{b} generated from tomograms that are currently captured. Here, it is preferable in the partial blood vessel models Vₐ₁ to Vₐₙ that a line parallel to the scanning direction at the time of image capturing using OCT be included in the same region. The division number n of the blood vessel model is an arbitrary number, and the division number n may be dynamically changed in accordance with the tomogram size (X, Y, Z).

As in steps S1204 and S1205 of the third embodiment, continuity of tomogram volume data is determined from the degree of similarity obtained from tomograms captured at different times.

### Eighth Embodiment

In the foregoing embodiments, the determining unit 253 performs determination by combining the evaluation of the degree of similarity and the detection of blood vessel ends. For example, using the partial integrated images Pₐ₁ to Pₐₙ or the partial blood vessel models Vₐ₁ to Vₐₙ, the determining unit 253 evaluates the degree of similarity between tomograms captured at different times. Only in the partial integrated images P ₐ₁ to Pₐₙ or the partial blood vessel models Vₐ₁ to Vₐₙ whose degrees of similarity are less than the threshold, the determining unit 253 may track blood vessels and detect blood vessel ends, and may determine continuity of the tomogram volume data.

### Other Embodiments

In the foregoing embodiments, whether to capture an image of the subject's eye again may automatically be determined. For example, when the determining unit 253 determines discontinuity, an image is captured again. Alternatively, an image is captured again when the place where discontinuity is determined is within a certain range from the image center. Alternatively, an image is captured again when discontinuity is determined at multiple places. Alternatively, an image is captured again when the amount of a positional shift estimated from a blood vessel pattern is greater than or equal to a threshold. Estimation of the amount of a positional shift may be performed not necessarily from a blood vessel pattern, but may be performed by performing comparison with a past image. Alternatively, an image is captured again in accordance with whether the eye is normal or has a disease, and, when the eye has a disease, an image is captured again when discontinuity is determined Alternatively, an image is captured again when discontinuity is determined at a place where a disease (leucoma or bleeding) existed, compared with past data. Alternatively, an image is captured again when there is a positional shift at a place whose image is specified by a doctor or an operator to be captured. It is not necessary to perform these processes independently, and a combination of these processes may be performed. When it is determined to capture an image again, the flow returns to the beginning, and the process is performed on the same subject's eye again.

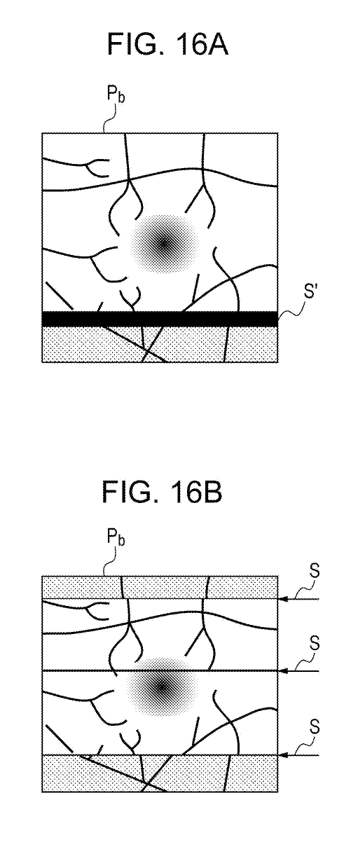

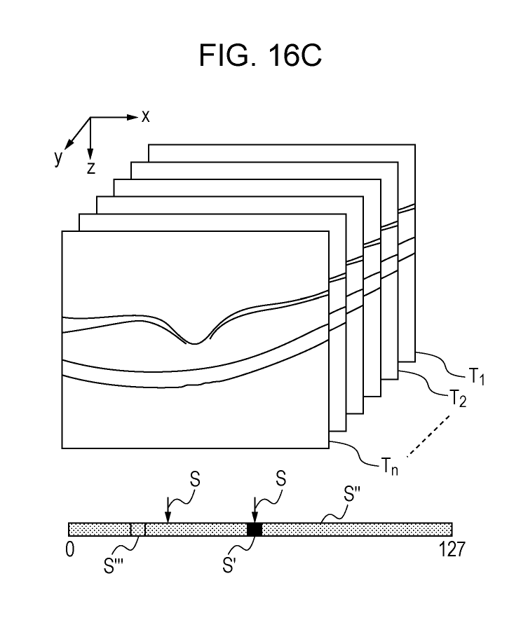

In the foregoing embodiments, a display example of the display unit 260 is not limited to that illustrated in FIG. 6. For example, other examples will be described using FIGS. 16A to 16C. FIGS. 16A to 16C are schematic diagrams illustrating examples of a screen display. FIG. 16A illustrates an example in which the amount of a positional shift is estimated from a blood vessel pattern, and that amount of the positional shift is explicitly illustrated in the integrated image P_{b}. An S′ region indicates an estimated not-captured region. FIG. 16B illustrates an example in which discontinuity caused by a positional shift or blinking is detected at multiple places. In this case, boundary tomograms at all of the places may be displayed at the same time, or boundary tomograms at places where the amounts of positional shifts are great may be displayed at the same time. Alternatively, boundary tomograms at places near the center or at places where there was a disease may be displayed at the same time. When tomograms are also to be displayed at the same time, it is preferable to inform an operator by using colors or numerals indicating which tomogram being displayed corresponds to which place. Boundary tomograms to be displayed may be freely changed by the operator using a GUI (not shown). FIG. 16C illustrates tomogram volume data T₁ to Tₙ, and a slider S″ and a knob S′″ for operating a tomogram to be displayed. A marker S indicates a place where discontinuity of tomogram volume data is detected. Further, the amount of a positional shift S′ may explicitly be displayed on the slider S″. When there are past images or wide images in addition to the foregoing images, these images may also be displayed at the same time.

In the foregoing embodiments, an analysis process is performed on a captured image of the macula lutea. However, a place for the image processing unit to determine continuity is not limited to a captured image of the macula lutea. A similar process may be performed on a captured image of the optic disk. Furthermore, a similar process may be performed on a captured image including both the macula lutea and the optic disk.

In the foregoing embodiments, an analysis process is performed on the entirety of an obtained three-dimensional tomogram. However, a target cross section may be selected from a three-dimensional tomogram, and a process may be performed on the selected two-dimensional tomogram. For example, a process may be performed on a cross section including a specific portion (e.g., fovea) of the fundus of an eye. In this case, the boundary between detected layers, a normal structure, and normal data constitute two-dimensional data on this cross section.

Determination of continuity of tomogram volume data using the image processing system 10, which has been described in the foregoing embodiments, may not necessarily be performed independently, and may be performed in combination. For example, continuity of tomogram volume data may be determined by simultaneously evaluating the degree of concentration of blood vessel ends, which is obtained from an integrated image generated from tomograms, as in the first embodiment, and the degree of similarity between consecutive tomograms and image feature values, as in the second embodiment. For example, detection results and image feature values obtained from tomograms with no positional shift and from tomograms with positional shifts may be learned, and continuity of tomogram volume data may be determined by using an identifier. Needless to say, any of the foregoing embodiments may be combined.

In the foregoing embodiments, the tomogram capturing apparatus 20 may not necessarily be connected to the image processing system 10. For example, tomograms serving as processing targets may be captured and held in advance in the data server 40, and processing may be performed by reading these tomograms. In this case, the image obtaining unit 220 gives a request for the data server 40 to send tomograms, obtains the tomograms sent from the data server 40, and performs layer boundary detection and quantification processing. The data server 40 may not necessarily be connected to the image processing system 10. The external storage device 704 of the image processing system 10 may serve the role of the data server 40.

Needless to say, the present invention may be achieved by supplying a storage medium storing program code of software for realizing the functions of the foregoing embodiments to a system or apparatus, and reading and executing the program code stored in the storage medium by using a computer (or a CPU or a microprocessing unit (MPU)) of the system or apparatus.

In this case, the program code itself read from the storage medium realizes the functions of the foregoing embodiments, and a storage medium storing the program code constitutes the present invention.

As a storage medium for supplying the program code, for example, a floppy disk, a hard disk, an optical disk, a magneto-optical disk, a compact disc read-only memory (CD-ROM), a compact disc-recordable (CD-R), a magnetic tape, a nonvolatile memory card, or a ROM can be used.

As well as realizing the functions of the foregoing embodiments by executing the program code read by the computer, an operating system (OS) running on the computer may execute part of or the entirety of actual processing on the basis of instructions of the program code to realize the functions of the foregoing embodiments.

Furthermore, a function expansion board placed in the computer or a function expansion unit connected to the computer may execute part of or the entirety of the processing to realize the functions of the foregoing embodiments. In this case, the program code read from the storage medium may be written into a memory included in the function expansion board or the function expansion unit. On the basis of the instructions of the program code, a CPU included in the function expansion board or the function expansion unit may execute the actual processing.

The description of the foregoing embodiments only describes an example of a preferred image processing apparatus according to the present invention, and the present invention is not limited thereto.

As many apparently widely different embodiments of the present invention can be made without departing from the spirit and scope thereof, it is to be understood that the invention is not limited to the specific embodiments thereof except as defined in the claims.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-287754, filed Nov. 10, 2008, which is hereby incorporated by reference herein in its entirety.

1. An image processing apparatus for determining an image capturing state of a subject's eye, comprising:
an image processing unit configured to obtain information indicating continuity of tomograms of the subject's eye; and
a determining unit configured to determine the image capturing state of the subject's eye on the basis of the information obtained by the image processing unit.

2. The image processing apparatus according to claim 1,
wherein the image processing unit obtains the degree of similarity between cross-sectional images constituting each of the tomograms, and the determining unit determines the image capturing state of the subject's eye on the basis of the degree of similarity between the cross-sectional images.

3. The image processing apparatus according to claim 1,
wherein the image processing unit obtains, from the tomograms, position information of blood vessel ends, and the determining unit determines the image capturing state of the subject's eye on the basis of the number of blood vessel ends in cross-sectional images that are two-dimensional tomograms of the tomograms.

4. The image processing apparatus according to claim 1,
wherein the image processing unit obtains the degree of similarity between tomograms of the subject's eye captured at different times, and
wherein the determining unit determines the image capturing state of the subject's eye on the basis of the degree of similarity between the tomograms.

5. The image processing apparatus according to claim 2,
wherein the determining unit determines how much the subject's eye moved or whether the subject's eye blinked, on the basis of the degree of similarity between the cross-sectional images.

6. The image processing apparatus according to claim 3,
wherein the determining unit determines how much the subject's eye moved or whether the subject's eye blinked, on the basis of the number of blood vessel ends in the cross-sectional images.

7. The image processing apparatus according to claim 1, further comprising an integrated image generating unit configured to generate an integrated image by integrating the tomograms in a depth direction,
wherein the image processing unit obtains, from the integrated image, one of the degree of similarity or the number of blood vessel ends.

8. An image processing apparatus according to claim 1, further comprising an integrated image generating unit configured to generate an integrated image by integrating the tomograms in a depth direction,
wherein the image processing unit obtains, from the integrated image, information of a region including an edge, and
wherein the determining unit determines the image capturing state of the subject's eye on the basis of the length of the edge.

9. An image processing apparatus for determining continuity of tomograms of a subject's eye, comprising:
an image processing unit configured to obtain, from the tomograms, position information of blood vessel ends; and
a determining unit configured to determine the continuity of the tomograms in accordance with the number of blood vessel ends, which are obtained by the image processing unit, in cross-sectional images that are two-dimensional tomograms of the tomograms.

10. An image processing apparatus for determining continuity of tomograms of a subject's eye, comprising:
an image processing unit configured to perform a Fourier transform of the tomograms; and
a determining unit configured to determine the continuity of the tomograms on the basis of the value of power obtained by the Fourier transform performed by the image processing unit.

11. An image processing apparatus for determining an image capturing state of a subject's eye, comprising:
an image processing unit configured to perform a Fourier transform of tomograms; and
a determining unit configured to determine the image capturing state of the subject's eye on the basis of the value of power obtained by the Fourier transform performed by the image processing unit.

12. An image processing method of determining an image capturing state of a subject's eye, comprising:
an image processing step of obtaining information indicating continuity of tomograms of the subject's eye; and
a determining step of determining the image capturing state of the subject's eye on the basis of the information obtained in the image processing step.

13. An image processing method of determining continuity of tomograms of a subject's eye, comprising:
an image processing step of obtaining, from the tomograms, position information of blood vessel ends; and
a determining step of determining the continuity of the tomograms in accordance with the number of blood vessel ends, which are obtained in the image processing step, in cross-sectional images that are two-dimensional tomograms of the tomograms.

14. An image processing method of determining continuity of tomograms of a subject's eye, comprising:
an image processing step of performing a Fourier transform of the tomograms; and
a determining step of determining the continuity of the tomograms on the basis of the value of power obtained by the Fourier transform performed in the image processing step.

15. An image processing method of determining continuity of tomograms of a subject's eye, comprising:
an image processing step of obtaining the degree of similarity between cross-sectional images constituting each of the tomograms; and
a determining step of determining the continuity of the tomograms on the basis of the degree of similarity obtained in the image processing step.

16. An image processing method of determining an image capturing state of a subject's eye, comprising:
an image processing step of performing a Fourier transform of tomograms; and
a determining step of determining the image capturing state of the subject's eye on the basis of the value of power obtained by the Fourier transform performed in the image processing step.

17. A program for causing a computer to perform the image processing method according to claim 12.

18. A storage medium storing the program according to claim 17.

19. A tomogram capturing apparatus for capturing a tomogram of a subject's eye, comprising:
an image processing unit configured to obtain information indicating continuity of tomograms of the subject's eye; and
a determining unit configured to determine an image of the subject's eye again on the basis of the information obtained by the image processing unit.

20. A tomogram capturing method, comprising:
an image processing step of obtaining information indicating continuity of tomograms of the subject's eye; and
a determining step configured to determine an image of the subject's eye again on the basis of the information obtained by the image processing step.

21. A storage medium storing the program according to claim 20.
